(19) United States
(12) Patent Application Publication
(10) Pub. No.: US 2009/0278797 A1
(43) Pub. Date: Nov. 12, 2009

(54) METHOD AND SYSTEM FOR OPERATING PERSONAL COMPUTER THROUGH MOTION RECOGNITION

(75) Inventors: Ta-Chung HSU, Taipei (TW); Yu-Wen Chien, Taipei (TW)

Correspondence Address: RABIN & Berdo, PC, 1101 14TH STREET, NW, SUITE 500, WASHINGTON, DC, 20005, US

(73) Assignee: INVENTEC CORPORATION, Taipei (TW)

(21) Appl. No.: 12/366,812

(22) Filed: Feb. 6, 2009

(30) Foreign Application Priority Data
May 9, 2008 (TW) 097117286

(51) Int. Cl. G09G 5/08

(52) U.S. Cl. 345/157

(57) ABSTRACT

A method and a system for operating a personal computer through motion recognition are described to enable the personal computer to perform corresponding operations in response to finger motions of a user. The system comprises of a plurality of colored finger cots respectively worn on different fingers of the user; an image capturing unit for capturing digital images of all the finger cots; an motion recognition procedure for recognizing relative positions and moving directions of all the finger cots in the digital images; and a command control procedure for generating a corresponding command to control the personal computer to perform relative operations according to a set motion-command conversion table and a result of the motion recognition.

### CROSS-REFERENCE TO RELATED APPLICATIONS

This non-provisional application claims priority under 35 U.S.C. § 119(a) on Patent Application No(s). 097117286 filed in Taiwan, R.O.C. on May 9, 2008 the entire contents of which are hereby incorporated by reference.

### BACKGROUND OF THE INVENTION

1. Field of Invention

The present invention relates to a method and a system for operating a personal computer, in particularly, to a method and a system capable of enabling a personal computer to perform corresponding operations according to finger motions of a user.

2. Related Art

Currently, a personal computer is operated through an input device, such as a keyboard, a mouse, a handwriting tablet, or a joystick. For more convenience in operation, in recent years, a touch panel has been developed to serve as an input device. Tablet PC is a typical example in which the touch panel is in combination with a frame, and the tablet PC is operated by clicking corresponding functions on the frame. In this manner, the tablet PC may achieve the same input effect without a keyboard or a mouse.

There are mainly resistance-type and capacitive-type touch panels. A resistance-type touch screen is the most commonly adopted technique at present and works under a driving principle of employing voltage drop to search for a coordinate axis. The X-axis and Y-axis on the resistance-type touch screen are driven by a pair of voltages of 0-5 V. When touched, the resistance-type touch screen generates a voltage drop due to the conduction of a loop, and a controller calculates a corresponding coordinate axis according to the voltage drop.

However, the touch panel has a cost much higher than that of a keyboard or a mouse, and thus cannot effectively replace other input interfaces. Moreover, the touch panel has a limited number of clicks, so the service life thereof is greatly affected.

Therefore, graphic recognition is further proposed to serve as an input interface for a personal computer. Taiwan Invention Patent No. 158066 has disclosed a “Data Processing System for Inputting Data through Finger Motions”. Taiwan Invention Patent No. 158066 combines multiple mouse buttons with a button sequence displayed on a frame to enable a personal computer to execute a corresponding application. In order to realize the operation mode in the above Patent No. 158066, a corresponding mouse is additionally provided, and the user needs to operate according to the button sequence on the frame. Thereby, the user in operation sometimes may not instantly find the right button, and as a result a manipulation instruction cannot be executed correctly.

### SUMMARY OF THE INVENTION

Accordingly, in order to solve the above problems, the present invention is mainly directed to a method for operating a personal computer through finger motion.

Therefore, a method for operating a personal computer through motion recognition is provided. The method includes the steps of: first, providing a first colored finger cot and a second colored finger cot, and setting by the personal computer the first colored finger cot as a first pointer and the second colored finger cot as a second pointer; then, capturing a plurality of digital images; selecting a reference image and a comparison image from the digital images; performing an motion recognition procedure, so as to determine a manipulation instruction according to position and relative distance variations between the first pointer and the second pointer in the reference image and the comparison image; and finally performing a command control procedure, so as to enable the personal computer to execute a corresponding application according to the manipulation instruction.

A system for operating a personal computer through motion recognition is further provided. The system includes an image capturing unit and a personal computer. The personal computer captures a finger motion of a user through the image capturing unit, so as to enable the personal computer to perform a corresponding application.

In order to achieve the above objective, the system for operating a personal computer through motion recognition provided by the present invention includes a first pointer, a second pointer, a motion recognition procedure, a storage unit, and a processing unit.

A finger of the user is selected to wear the first colored finger cot and defined as the first pointer, and another finger of the user is selected to wear the second colored finger cot and defined as the second pointer. The color of the first colored finger cot is different from that of the second colored finger cot. The motion recognition procedure is used to select the reference image and the comparison image from the digital images, and output a manipulation instruction to execute a corresponding application according to position and relative distance variations between the first pointer and the second pointer in the reference image and the comparison image. The storage unit is disposed in the personal computer for storing the digital images and the motion recognition procedure. The processing unit is disposed in the personal computer and electrically connected to the storage unit, for performing the motion recognition procedure.

According to the present invention, the colored finger cots respectively worn on the fingertips of the user can be used to trace and recognize the track of a finger motion, so as to trigger a corresponding application in the personal computer.

### BRIEF DESCRIPTION OF THE DRAWINGS

The present invention will become more fully understood from the detailed description given herein below for illustration only, and thus are not limitative of the present invention, and wherein:

FIG. 1 is a schematic view illustrating the architecture of the present invention;

FIG. 2 is a schematic view illustrating the operation flow of the present invention;

FIG. 3 is a schematic view of a finger motion according to the present invention;

FIG. 4 is an motion-command instruction table composed of finger motions and applications according to the present invention;

FIG. 5 shows schematic views of a finger motion;

FIG. 6 is a schematic view showing distance variations between the first pointer and other pointers;

FIG. 7 is a schematic view showing distance variations between the first pointer and other pointers; and

FIG. 8 is a schematic view showing positions of the first pointer and the second pointer.

### DETAILED DESCRIPTION OF THE INVENTION

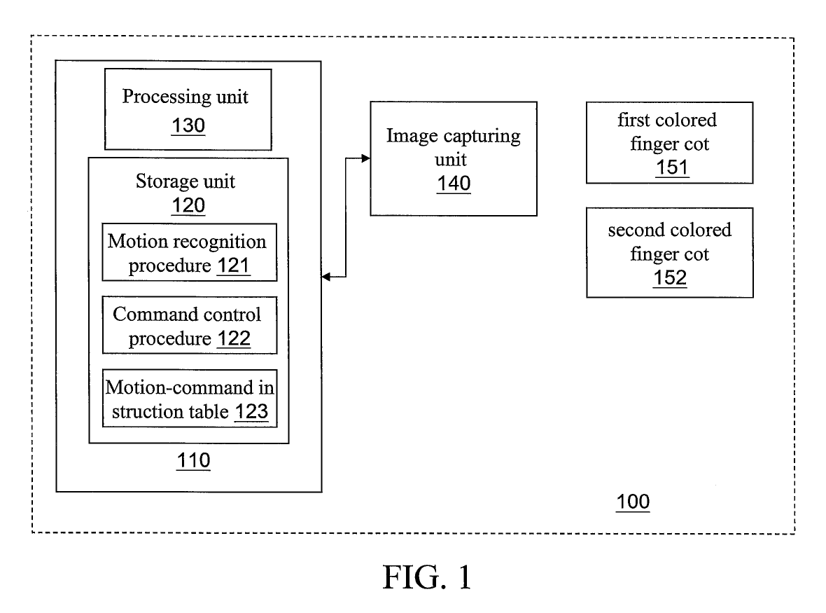

The present invention combines a personal computer with an image capturing unit, and enables the personal computer to perform corresponding operations according to finger motions of a user. FIG. 1 is a schematic view illustrating the architecture of the present invention. The operating system 100 of the present invention includes a personal computer 110 and an image capturing unit 140. The image capturing unit 140 is electrically connected to the personal computer 110, for capturing a plurality of digital images. The image capturing unit 140 is, but not limited to, a web cam, a digital camera, or any other image source. Further, the personal computer 110 at least includes a storage unit 120, an motion recognition procedure 121, a command control procedure 122, an motion-command instruction table 123, and a processing unit 130.

The processing unit 130 is electrically connected to the storage unit 120, for performing the motion recognition procedure 121 and setting a first pointer and a second pointer. In this embodiment, a finger of the user is selected to wear a first colored finger cot 151 and is identified as the first pointer by the personal computer 110 accordingly. Further, another finger of the user is selected to wear a second colored finger cot 152 and is identified as the second pointer by the personal computer 110 accordingly. Similarly, the present invention may increase the number of the colored finger cots. The colored finger cots may be realized by finger cots of different colors or light emitting diodes (LEDs) of different colors. In an optimal implementation aspect, the colored finger cots each have a different color. For example, the first colored finger cot 151 may be red, the second colored finger cot 152 may be green, and the third colored finger cot may be blue.

The motion recognition procedure 121 is used to select a reference image and a comparison image from the digital images, and operate according to position and relative distance variations between the first pointer and the second pointer in the reference image and the comparison image. Taking the relative distance variation for example, the distance between the first pointer and the second pointer in the reference image is calculated with the first pointer in the reference image as a reference point. Then, the distance between the first pointer and the second pointer in the comparison image is calculated with the first pointer in the comparison image as a reference point. Finally, a distance variation between the first pointer and the second pointer in the reference image and the comparison image is calculated. If the distance variation meets a set value, a manipulation instruction is output. In addition to the above distance variation, position and direction variations between the pointers can be adopted to deal with above three pointers.

When the command control procedure 122 receives the manipulation instruction, the personal computer 110 executes a corresponding application according to the manipulation instruction. In other words, whether to execute a corresponding application is determined according to the movement variation of the first pointer and the second pointer. The storage unit 120 is disposed in the personal computer 110 for storing the digital images and the motion recognition procedure 121.

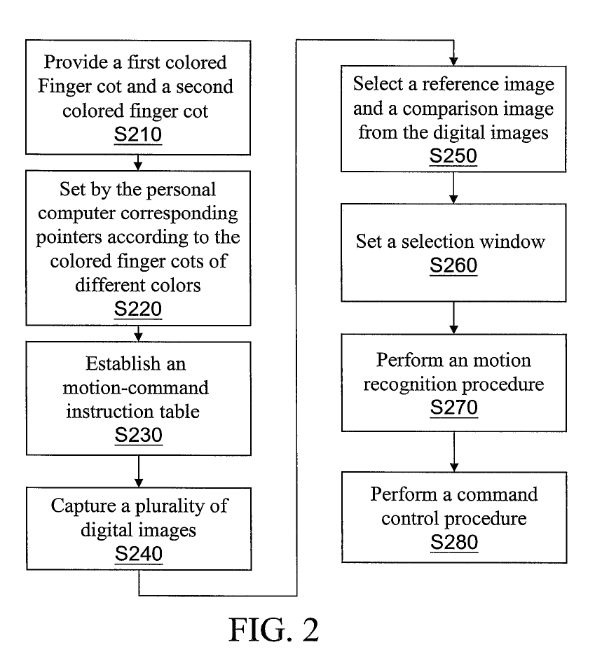

FIG. 2 is a schematic view illustrating the operation flow of the present invention. The operation flow includes the following steps. Firstly, a first colored finger cot and a second colored finger cot are provided (Step S210).

The personal computer determines corresponding pointers according to the colored finger cots of different colors (Step S220). For example, the personal computer sets the first colored finger cot 151 worn by the user as a first pointer and sets the second colored finger cot 152 worn by the user as a second pointer. Similarly, the personal computer 110 sets the pointers in a number corresponding to that of the colored finger cots. Then, an motion-command instruction table is established (Step S230). The motion-command instruction table 123 is composed of a position variation combination of each pointer and a corresponding application thereof to be executed.

A plurality of digital images is capture (Step S240). A reference image and a comparison image are selected from the digital images (Step S250). Generally, the image capturing unit 140 in operation captures the digital images continuously. In this embodiment, two consecutive digital images are respectively set as the reference image and the comparison image. In addition to the consecutive digital images, digital images spaced from each other by a specific number of digital images may also serve as the reference image and the comparison image. Then, a selection window is set (Step S260). When detecting that the first pointer and the second pointer exist in the selection window, the personal computer 110 performs the motion recognition procedure 121.

The motion recognition procedure is performed (Step S270), so as to output the manipulation instruction according to the positions of the first pointer in the reference image and the comparison image, the positions of the second pointer in the reference image and the comparison image, and the distance variation between the second pointer and the first pointer in the reference image and the comparison image. The command control procedure is performed (Step S280), such that the personal computer 110 looks up the motion-command instruction table 123 according to the manipulation instruction, so as to execute a corresponding application.

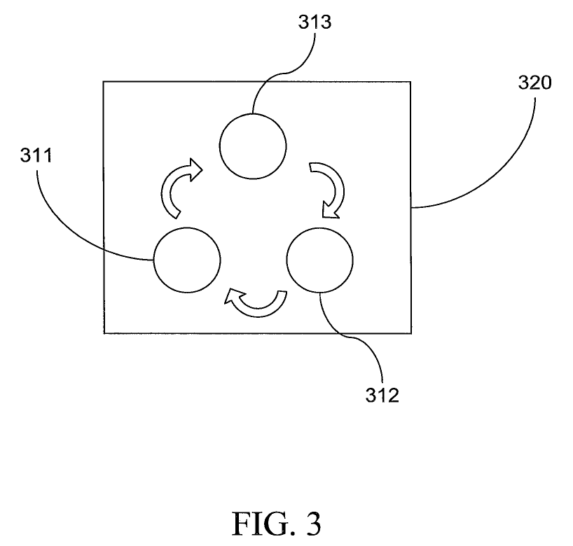

In order to explain the operation of the present invention more explicitly, three fingers of the user are adopted herein for illustration in this embodiment. FIG. 3 is a schematic view of a finger motion according to the present invention. The first colored finger cot 151, the second colored finger cot 152, and the third colored finger cot worn by the user are respectively set as a first pointer 311, a second pointer 312, and a third pointer 313. In FIG. 3, circular blocks are used to represent different pointers, and arrows indicate the moving directions of the pointers.

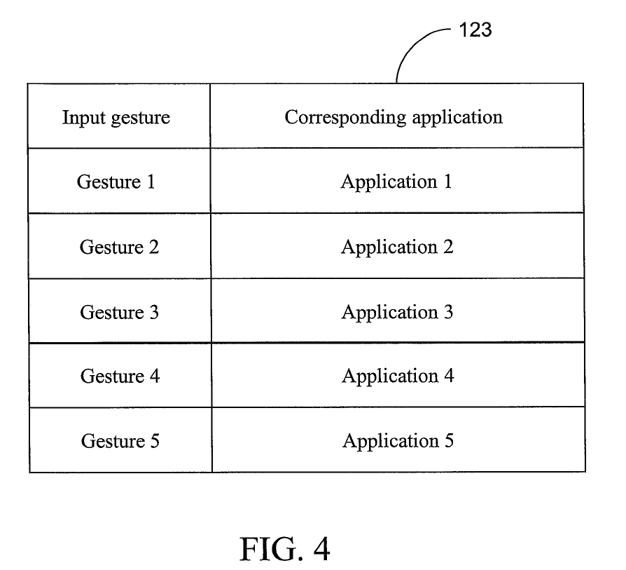

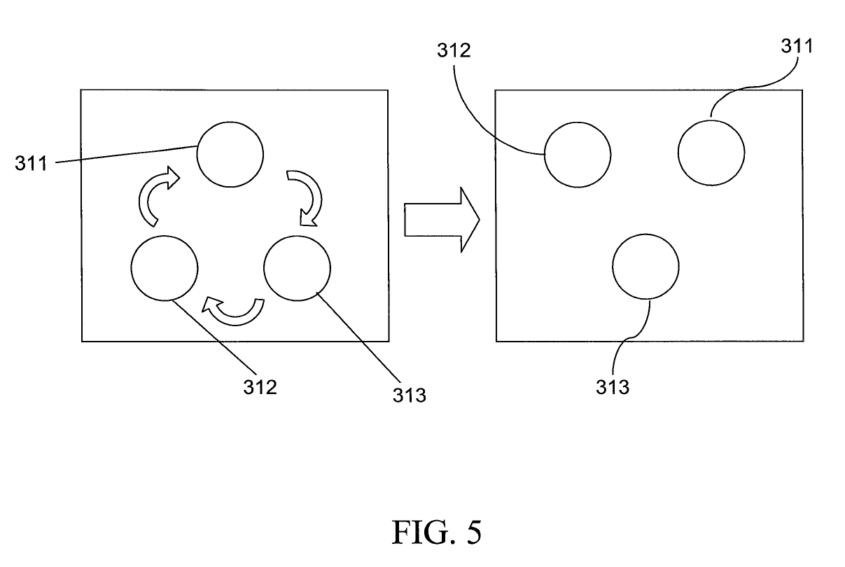

FIG. 4 is an motion-command instruction table 123 composed of finger motions and applications according to the present invention. The table records a position variation combination of each pointer and establishes a corresponding application thereof to be executed. The position variations of the pointers are reflected by the positions of the first pointer 311, the second pointer 312, and the third pointer 313 in two consecutive digital images. FIG. 5 shows schematic views of a finger motion.

In FIG. 5, the left image shows the finger positions of the user before a finger motion. Thus, the left image can be regarded as the reference image in the motion recognition procedure 121, and the right image can be regarded as the comparison image in the motion recognition procedure 121. FIG. 5 shows a rotation of the fingers, so the finger positions of the user after the rotation are as shown in the right image of FIG. 5. The personal computer 110 adopts relative positions between the first pointer 311 and the second pointer 312, and between the first pointer 311 and the third pointer 313 in different digital images as a basis for variation. Subsequently, the user assigns a corresponding application according to the finger motion.

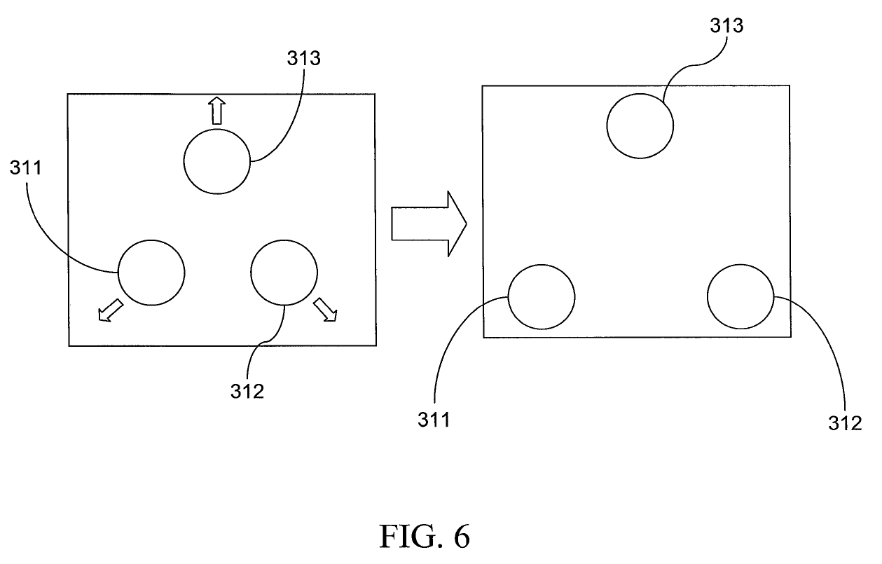

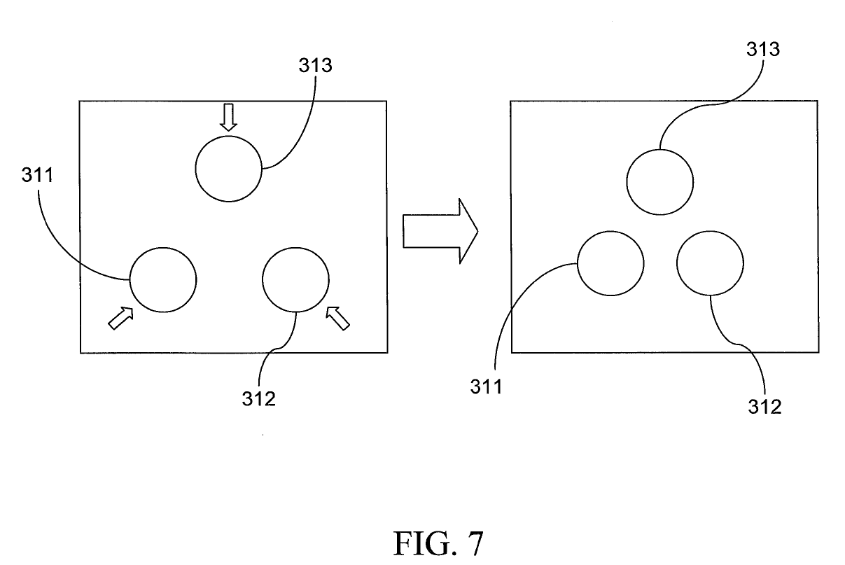

In addition to the relative positions, relative distances or moving directions between the pointers may also be adopted as a basis for variation. FIGS. 6 and 7 respectively show distance variations between the first pointer 311 and other pointers. In FIG. 6, the first pointer 311, the second pointer 312, and the third pointer 313 simultaneously move outwards, so that the distance between the first pointer 311 and the second pointer 312 and the distance between the first pointer 311 and the third pointer 313 vary at the same time.

On the contrary, in FIG. 7, the first pointer 311, the second pointer 312, and the third pointer 313 simultaneously move inwards, so that the distance between the first pointer 311 and the second pointer 312 and the distance between the first pointer 311 and the third pointer 313 vary at the same time. According to the above variations, the user may assign corresponding applications respectively.

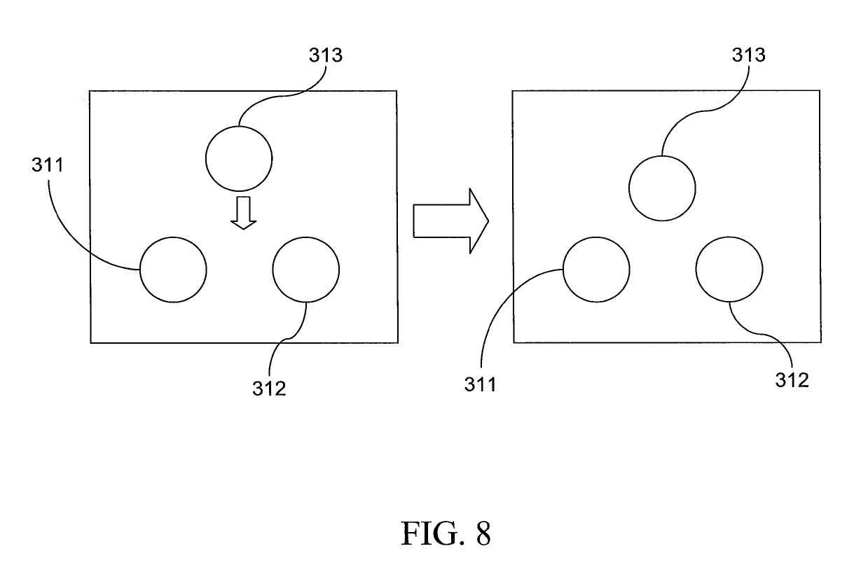

Besides adopting one pointer as a reference for determination, the present invention may conduct determination according to distance variations (or moving direction or position variations) between multiple pointers. For example, in FIG. 8, the positions of the first pointer 311 and the second pointer 312 are fixed, and only the third pointer 313 moves, so that the distance between the first pointer 311 and the third pointer 313 and the distance between the second pointer 312 and the third pointer 313 vary at the same time. According to the above variations, the user may assign corresponding applications respectively.

A selection window 320 is set in the digital images captured by the image capturing unit 140. Thereby, when detecting the first pointer 311 and the second pointer 312 exist in the selection window 320, the personal computer 110 performs a corresponding motion operation procedure. The selection window 320 may be a portion of or the whole of a digital image. The personal computer 110 performs the motion recognition procedure 121, and outputs a corresponding manipulation instruction to execute a corresponding application according to the positions of the first pointer 311 in the reference image and the comparison image, the positions of the second pointer 312 in the reference image and the comparison image, and a distance variation between the second pointer 312 and the first pointer 311 in the reference image and the comparison image.

According to the present invention, the colored finger cots respectively worn on the fingertips of the user can be used to trace and recognize the track of a finger motion, so as to trigger a corresponding application in the personal computer 110.

What is claimed is:

1. A method for operating a personal computer through motion recognition, wherein the personal computer captures a finger motion of a user by an image capturing unit, so as to execute a corresponding application, the method comprising:
providing a first colored finger cot and a second colored finger cot, and respectively wearing the first and second colored finger cots on the fingers of the user;
capturing a plurality of digital images comprising the colored finger cots;
setting, by the personal computer, the first colored finger cot as a first pointer and the second colored finger cot as a second pointer;
selecting a reference image and a comparison image from the digital images;
performing an motion recognition procedure, so as to output a manipulation instruction according to position and relative distance variations between the first pointer and the second pointer in the reference image and the comparison image; and
performing a command control procedure, so as to enable the personal computer to execute a corresponding application according to the manipulation instruction.

2. The method for operating a personal computer through motion recognition according to claim 1, further comprising setting a selection window, such that the motion recognition procedure is performed when it is detected that the first pointer and the second pointer exist in the selection window.

3. The method for operating a personal computer through motion recognition according to claim 1, wherein the motion recognition procedure further determines a third pointer according to a third colored finger cot, and the motion recognition procedure is used to trigger a corresponding application according to relative distance and displacement variations between the first pointer, the second pointer, and the third pointer in the reference image and the comparison image.

4. The method for operating a personal computer through motion recognition according to claim 1, further comprising establishing an motion-command instruction table before performing the motion recognition procedure, so as to record position variation combinations of the pointers in the motion recognition procedure into the motion-command instruction table, and assign a corresponding application according to the position variation combinations respectively.

5. An operating system applicable to the operating method in claim 1, wherein the system has an image capturing unit and a personal computer, and the personal computer captures a finger motion of a user by the image capturing unit, so as to execute a corresponding application, the operating system comprising:
a first colored finger cot, having a first color and capable of being worn on a finger of the user;
a second colored finger cot, having a second color and capable of being worn on a finger of the user;
an motion recognition procedure, for selecting a reference image and a comparison image from digital images, then setting the first colored finger cot worn on the finger of the user in the digital images as a first pointer, setting the second colored finger cot worn on the finger of the user as a second pointer, and outputting a manipulation instruction according to a position of the first pointer in the reference image and the comparison image, a position of the second pointer in the reference image and the comparison image, and a distance variation between the second pointer and the first pointer in the reference image and the comparison image;
a command control procedure, for enabling the personal computer to execute a corresponding application according to the manipulation instruction;
a storage unit, disposed in the personal computer, for storing the digital images, the motion recognition procedure, and the command control procedure; and
a processing unit, disposed in the personal computer, and electrically connected to the storage unit, for performing the motion recognition procedure.

6. The operating system applicable to the operating method in claim 1 according to claim 5, further comprising a third colored finger cot having a third color, wherein the motion recognition procedure sets the third colored finger cot as a third pointer, and triggers a corresponding application according to relative distance and displacement variations between the first pointer, the second pointer, and the third pointer in the reference image and the comparison image.

7. The operating system applicable to the operating method in claim 1 according to claim 6, wherein the first colored finger cot, the second colored finger cot, and the third colored finger cot are in different colors.

8. The operating system applicable to the operating method in claim 1 according to claim 5, further comprising an motion-command instruction table established by the motion recognition procedure according to position variations of the pointers.
